(19) United States
(12) Patent Application Publication
(10) Pub. No.: US 2008/0200298 A1
(43) Pub. Date: Aug. 21, 2008

(54) FORWARD AND REARWARD MOTION SWITCHING MECHANISM USING BRAKE BAND

(75) Inventor: Moriya SUZUKI, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 12/023,025

(22) Filed: Jan. 30, 2008

(30) Foreign Application Priority Data
Feb. 15, 2007 (JP) 2007-035374

(51) Int. Cl. F16H 3/44

(52) U.S. Cl. 475/311; 475/269; 475/347

(57) ABSTRACT

A forward and rearward motion switching device to be used in an automatic transmission system for a vehicle, comprises a planetary mechanism provided with an input element, an element to be fixed and an output element which are disposed coaxially and are rotatable relative to each other, the planetary mechanism outputting a rotational driving force of an internal combustion engine transmitted to the input element as a rotational driving force in the reverse direction to the rotation of the input element from the output element through the input element, the element to be fixed and the output element, and a brake capable of fixing the element to be fixed of the planetary mechanism. The brake comprises a rotational drum which is integrally formed with the element to be fixed and has an outer peripheral surface, and a brake band that surrounds the outer peripheral surface of the rotational drum to fix the same.

This application claims the benefit of Japanese Patent Application No. 2007-035374 which is hereby incorporated by reference.

### BACKGROUND OF THE INVENTION

1. Field of the Invention

The present invention relates to a forward and rearward motion switching mechanism of an automatic transmission for a vehicle.

2. Related Background Art

An automatic transmission of a vehicle is equipped, between an input shaft connected to a torque converter and an output shaft, with a forward and rearward motion switching device and an automatic transmission device. The forward and rearward motion switching device and the automatic transmission device are constituted by a plurality of braking mechanisms, a plurality of clutch mechanisms and a plurality of planetary gear mechanisms together in combination. In the planetary gear mechanism, a sun gear having a small diameter and external teeth and a ring gear having a large diameter and internal teeth are provided coaxially and a pinion gear supported by a planetary carrier is disposed between the sun gear and the ring gear.

The automatic transmission device is arranged such that each of the sun gear, the ring gear and the planetary carrier of the planetary gear mechanism corresponds to either of an input element, an element to be fixed and an output element, and a ratio of speed of the output element with respect to the input element is changed, depending on which member is corresponding to which element. Then, selection of each of the members as the input element, the element to be fixed or the output element is performed by fastening or releasing a braking mechanism and a clutch mechanism connected to the respective elements.

Also in the forward and rearward motion switching device, each of the sun gear, the ring gear and the planetary carrier of the planetary gear mechanism is made correspond to either of an input element, an element to be fixed and an output element by fastening or releasing the braking mechanism and the clutch mechanism, so that the direction of rotation of the output element with respect to the input element is switched to the same as the direction of rotation of the input element or to the direction reverse thereto.

Automatic transmission systems for a vehicle are classified into those of a step variable transmission scheme utilizing a planetary gear mechanism as described above and those of a stepless or continuously variable transmission scheme which has higher fuel efficiency and has a belt and a pulley with no speed change shock, compared with those of the step variable transmission scheme (see Japanese Patent Application Laid-Open Nos. 2002-89687 and 2004-144139). There is also disclosed those with the above schemes combined together (see Japanese Patent Application Laid-Open No. 2002-98171). However, even in a vehicle employing a continuously variable transmission (hereinafter called a “CVT”), a planetary gear mechanism is used as a device for switching forward and rearward motions. In the above patent publications, a driving force inputted from an engine through a torque converter is used to switch forward and rearward motions by using a forward and rearward motion switching device (3) shown in FIG. 1 of Japanese Patent Application Laid-Open No. 2002-89687, or a forward and rearward motion switching device 60 shown in FIG. 1 of Japanese Patent Application Laid-Open No. 2004-144139, or a forward and rearward motion switching device 41 shown in FIG. 1 of Japanese Patent Application Laid-Open No. 2002-98171.

As the forward and rearward motion switching device employed in these CVTs, a single pinion type planetary gear mechanism or a double pinion type planetary gear mechanism is used. Generally, when the double pinion type planetary gear mechanism is used, the device makes a sun gear as an input element, a ring gear as an element to be fixed and a planetary carrier as an output element in rearward motion and outputs a rotation in the reverse direction to the rotation of the input element. When the single pinion type planetary gear mechanism is used, the device makes the sun gear as the input element, the planetary carrier as the element to be fixed and the ring gear as the output element, or the ring gear as the input element, the planetary carrier as the element to be fixed and the sun gear as the output element, in rearward motion and outputs a rotation in the reverse direction to the rotation of the input element. In these planetary gear mechanisms of the forward and rearward motion switching device, a wet type multiple disc brake is employed as a brake to be used as an element for fixing the ring gear or the planetary carrier in rearward motion.

However, in the forward and rearward motion switching device, the element to be fixed of the planetary gear mechanism is always rotating even when the engine is in rotation and the brake is not applied.

For this reason, when a wet type multiple disc brake is used in the planetary gear mechanism of the forward and rearward motion switching device, a drag torque between a friction disc and a separator disc of the wet type multiple disc brake gives adverse influence on the efficiency of the CVT. Since the fuel efficiency is highly demanded recently and improvement in efficiency of the CVT is strongly required, such reduction of the drag torque is highly demanded.

### SUMMARY OF THE INVENTION

The present invention has been contrived in view of these problems, and an object of the invention is to provide a forward and rearward motion switching device in which a drag torque can be reduced, compared with a wet type multiple disc brake having the equivalent capacity, thereby reducing a power loss and improving the fuel efficiency.

In order to solve the above problems, according to the present invention, there is provided a forward and rearward motion switching device to be used in an automatic transmission system for a vehicle, comprising: a planetary mechanism provided with an input element, an element to be fixed and an output element which are disposed coaxially and are rotatable relative to each other, the planetary mechanism outputting a rotational driving force of an internal combustion engine transmitted to the input element as a rotational driving force in the same direction as or reverse direction to the rotation of the input element from the output element through the input element, the element to be fixed and the output element; and a brake means capable of fixing the element to be fixed of the planetary mechanism, wherein the brake means comprises a rotational drum which is integrally formed with the element to be fixed and has an outer peripheral surface, and a brake band that surrounds the outer peripheral surface of the rotational drum to fix the same.

According to the present invention, the planetary mechanism is preferably a planetary gear mechanism comprising:
a sun gear, a pinion gear disposed outside in the radial direction of the sun gear and meshed with the sun gear, a planetary carrier for supporting the pinion gear to allow rotation and revolution thereof and a ring gear meshed with the sun gear through the pinion gear; said sun gear, said planetary carrier and said ring gear respectively constituting any of the input element, the element to be fixed and the output element.

Preferably, the forward and rearward motion switching device of the present invention is used in an automatic transmission system employing a continuously variable transmission.

In the forward and rearward motion switching device of the present invention, it is preferable that, in the planetary gear mechanism, the sun gear constitutes the input element, the ring gear constitutes the element to be fixed and the planetary carrier constitutes the output element, and when the ring gear is fixed by the brake band a rotational driving force of the internal combustion engine transmitted to the sun gear is outputted as a rotational driving force in the reverse direction to the rotation of the sun gear from the planetary carrier through the pinion gear.

Also, in the forward and rearward motion switching device of the present invention, it is preferable that, in the planetary gear mechanism, the sun gear constitutes the input element, the planetary carrier constitutes the element to be fixed and the ring gear constitutes the output element, and when the planetary carrier is fixed by the brake band a rotational driving force of the internal combustion engine transmitted to the sun gear is outputted as a rotational driving force in the reverse direction to the rotation of the sun gear from the ring gear through the pinion gear.

In the forward and rearward motion switching device of the present invention, it is preferable that, in the planetary gear mechanism, the ring gear constitutes the input element, the planetary carrier constitutes the element to be fixed and the sun gear constitutes the output element, and when the planetary carrier is fixed by the brake band a rotational driving force of the internal combustion engine transmitted to the ring gear is outputted as a rotational driving force in the reverse direction to the rotation of the ring gear from the sun gear through the pinion gear.

In the forward and rearward motion switching device of the present invention, preferably the output element is coupled to an input shaft of the automatic transmission system employing the continuously variable transmission.

With a forward and rearward motion switching device according to the present invention, it is possible to reduce a drag torque approximately by half, compared with a wet type multiple disc brake having the same capacity. Since capable of thus reducing a power loss, if used as a brake of a forward and rearward motion switching device of an automatic transmission, this arrangement can contribute to reduce fuel expenses. Particularly when this device is used in a vehicle employing a continuously variable transmission, higher efficiency of the continuously variable transmission can be achieved, to thereby greatly contribute fuel efficiency.

### BRIEF DESCRIPTION OF THE DRAWINGS

FIG. 1 is a skeleton diagram showing the structure of a forward and rearward motion switching device according to the first embodiment of the present invention;

FIG. 2 is a skeleton diagram showing the structure of a forward and rearward motion switching device according to the second embodiment of the present invention;

FIG. 3 is a skeleton diagram showing the structure of a forward and rearward motion switching device according to the first variation of the second embodiment of the present invention;

FIG. 4 is a skeleton diagram showing the structure of a forward and rearward motion switching device according to the second variation of the second embodiment of the present invention;

FIG. 5 is a perspective view showing a brake band which is used in the embodiments and the variations of the embodiment of the present invention; and

FIG. 6 is a graph showing a comparison result of the drag torque between the conventional device and the device of the present invention.

### DESCRIPTION OF THE PREFERRED EMBODIMENTS

A forward and rearward motion switching device according to the present invention will be described below with reference to drawings.

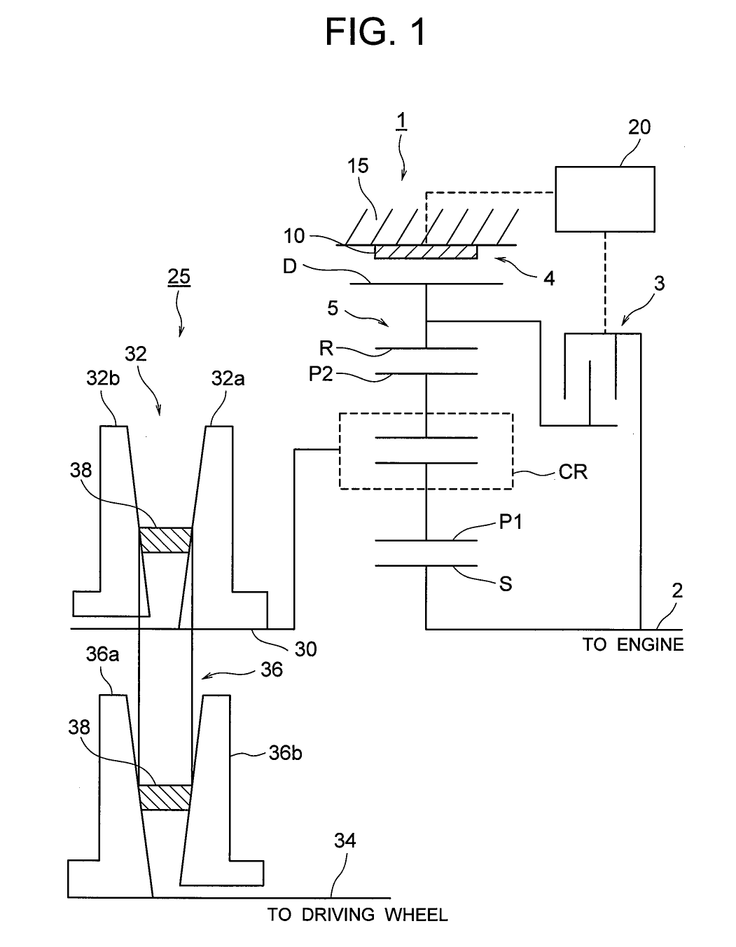

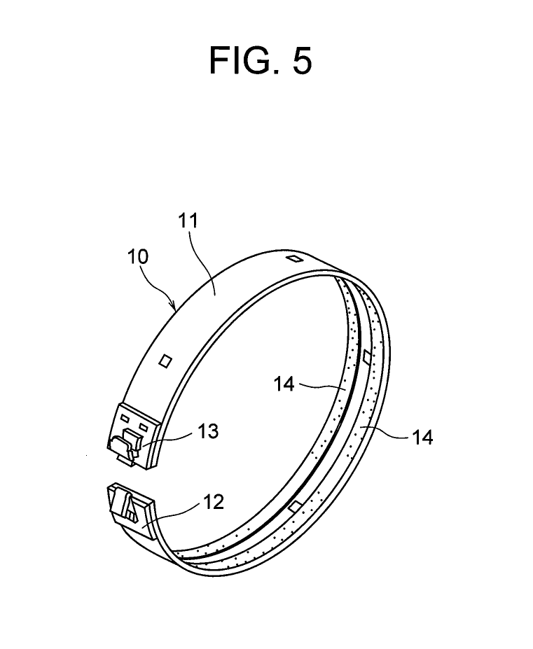

FIG. 1 is a skeleton diagram showing a structure of a forward and rearward motion switching device 1 according to a first embodiment of the present invention. The forward and rearward motion switching device 1 comprises a planetary gear mechanism 5 which is coupled to an input shaft 2 connected to an engine side through an unillustrated torque converter disposed on the right side of the figure and is disposed coaxially with the input shaft 2, and a brake 4 which is fixedly provided on a transmission case 15. In the present embodiment, the planetary gear mechanism 5 employs a planetary gear mechanism of a double pinion type. The planetary gear mechanism 5 is comprised of a sun gear S which is integrally coupled to the input shaft 2 to be rotation-driven, a pinion gear P1 which is disposed outside in the radial direction of the sun gear S and meshed with the sun gear S, a pinion gear P2 which is disposed on the outer diameter side of the pinion gear P1 and meshed with the pinion gear P1, a planetary carrier CR for supporting the pinion gears P1 and P2 to allow rotation about their own axes and revolution about the axis of the sun gear S, and a ring gear R provided with internal teeth meshed with the pinion gear P2. The ring gear R is integrally formed with a rotational drum D on the outer periphery thereof, and is releasably coupled to the input shaft 2 through a clutch 3. The outer peripheral surface of the rotational drum D is provided to be fixed by a brake 4 which will be described later with reference to FIG. 5. The planetary carrier CR is integrally coupled to a primary shaft 30 which is coaxial with the input shaft 2 to serve as an input shaft of the continuously variable transmission 25.

The continuously variable transmission 25 is provided with the primary shaft 30, a primary pulley 32 supported by the primary shaft 30, a secondary shaft 34 serving as an output shaft of the continuously variable transmission 25, a secondary pulley 36 supported by the secondary shaft 34, and a metal belt 38 spanning the primary pulley 32 and the secondary pulley 36 for coupling these two pulleys 32 and 36. The primary pulley 32 is provided with a fixed half pulley 32a which is integrally rotated with the primary shaft 30 and a movable half pulley 32b. The movable half pulley 32b is movably disposed to approach to or separated from the fixed half pulley 32a in the axial direction. A V-shaped groove is formed between the fixed half pulley 32a and the movable half pulley 32b. The secondary pulley 36 is provided with a fixed half pulley 36a which is integrally rotated with the secondary shaft 34 and a movable half pulley 36b. The movable half pulley 36b is movably disposed to approach to or separated from the fixed half pulley 36a in the axial direction. A V-shaped groove is formed between the fixed half pulley 36a and the movable half pulley 36b.

The movable half pulley 32b of the primary pulley 32 and the movable half pulley 36b of the secondary pulley 36 are respectively movable in the axial direction by using oil pressure. The width of the V-shaped grooves of the primary pulley 32 and the secondary pulley 36 can be changed upon movement of these movable half pulleys 32b and 36b. The structure is arranged such that the diameter of an arc formed by the metal belt 38 spanning the pulleys 32 and 36 is varied by changing the width of the V-shaped grooves of these pulleys 32 and 36.

The secondary shaft 34 is connected to an unillustrated differential gear device, and the differential gear device is connected to an unillustrated driving wheel.

In forward running of the vehicle, the clutch 3 is engaged through the control device 20, and a rotational driving force of the engine which is transmitted to the input shaft 2 through an unillustrated torque converter is transmitted to the sun gear S and the ring gear R, whereby the sun gear S and the ring gear R are integrally rotated in the same direction as the rotation of the input shaft 2. Upon the integral rotation of the sun gear S and the ring gear R, the planetary carrier CR is integrally rotated in the same direction through the pinion gears P1 and P2. That is, the sun gear S, the planetary gear CR and the ring gear R are integrally rotated in the same direction as the rotation of the input shaft 2, so that the rotation of the input shaft 2 is transmitted as it is to the primary shaft 30 of the continuously variable transmission 25 which is integrally coupled to the planetary carrier CR.

The primary pulley 32 which is integrally rotated with the primary shaft 30 is also rotated in the same direction, and the rotation of the primary pulley 32 is transmitted to the secondary pulley 36 through the metal belt 38. Here, when the movable half pulley 32b of the primary pulley 32 and the movable pulley 36b of the secondary pulley 36 are respectively moved in the axial direction by oil pressure, the width of the V-shaped grooves 32 and 36 of the two pulleys 32 and 36 is changed, and the diameter of the arc of the metal belt 38 spanning the two pulleys 32 and 36 is changed. With this, the rotation of the primary pulley 32 is continuously varied and is transmitted to the secondary pulley 36.

Thus, the rotational driving force in the same direction as the rotation of the input shaft 2 transmitted to the secondary shaft 34 is transmitted to the unillustrated driving wheels through the unillustrated differential gear device, whereby the vehicle is enabled to run forward.

On the other hand, in rearward running of the vehicle, the clutch 3 is released or disengaged through the control device 20, and the brake 4 which will be described later with reference to FIG. 5 is fastened, thereby fixing the rotational drum D. Since the brake 4 is fixedly provided on the transmission case 15, the ring gear R serves as an element to be fixed. For this reason, the rotational driving force of the engine transmitted to the input shaft 2 is transmitted to the sun gear S, and the planetary carrier CR is rotated in the reverse direction to the rotation of the input shaft 2 through the pinion gears P1 and P2. Thus, the primary shaft 30 of the continuously variable transmission 25 integrally coupled to the planetary carrier CR is rotated in the reverse direction to the rotation of the input shaft 2, and the primary pulley 32 provided on the primary shaft 30 is rotated also in the reverse direction to the rotation of the input shaft 2. The rotation of the primary pulley 32 is transmitted to the secondary pulley 36 through the metal belt 38. Thus, the secondary pulley 36 and the secondary shaft 34 are integrally rotated, and the rotational driving force in the reverse direction to the rotation of the input shaft 2 is transmitted to the driving wheels through the unillustrated differential gear device, whereby the vehicle is enabled to run rearward.

In the forward and rearward motion switching device 1 of the present embodiment, the brake band 10 is used as a braking means for fixing the ring gear R which serves as the element to be fixed of the planetary gear mechanism 5 in the rearward running of the vehicle. FIG. 5 is a perspective view of the brake band 10 which is used in the present embodiment. The brake band 10 is comprised of an annular strap 11 which is cut at one part, an anchor bracket 12 and an apply bracket 13 which are respectively provided at the cut ends of the strap 11, and a frictional member 14 fixed to the inner periphery of the strap 11. The ring gear R is provided on the inner diameter side of the strap 11. The anchor bracket 12 is fixedly provided on the transmission case 14 with an anchor pin (not shown), while the apply bracket 13 is provided to be movable.

When a force is applied by the apply pin (not shown)onto the apply bracket 13, the apply bracket 13 is displaced to come close to the anchor bracket 12, whereby the inner diameter of the brake band 10 is reduced and the inner peripheral surface of the brake band 10 is brought into pressure contact with the outer peripheral surface of the rotational drum D which is integrally formed on the outer periphery of the unillustrated ring gear R. With this arrangement, the outer peripheral surface of the rotational drum D is wound and fixed by the brake band 10, and the ring gear R is fixed in a stationary state.

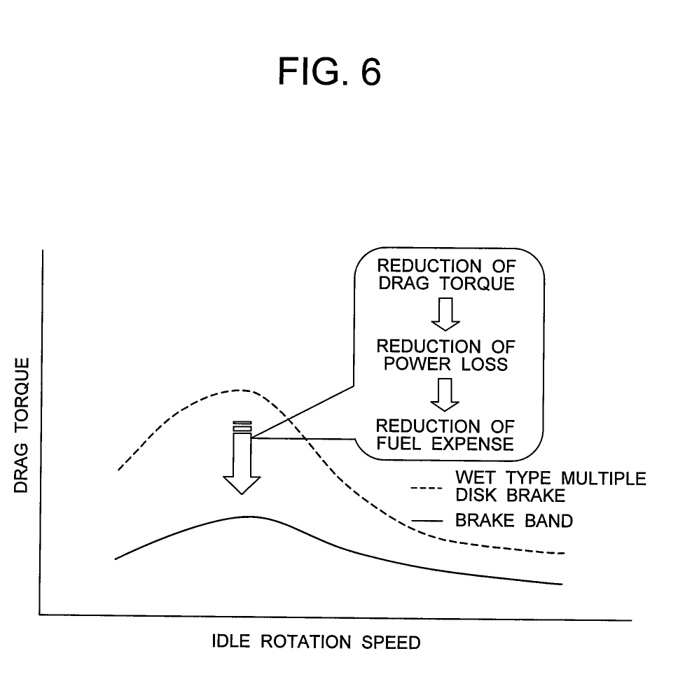

In FIG. 6, a drag torque between a friction disc and a separator disc in a conventional forward and rearward motion switching device using a wet type multiple disc brake is compared with a drag torque between the brake band 10 and the rotational drum D in the forward and rearward motion switching device 1 according to the present invention. As seen from FIG. 6, the drag torque between the brake band 10 and the rotational drum D in the forward and rearward motion switching device 1 according to the present invention is approximately a half the drag torque between the friction disc and the separator disc in the conventional forward and rearward motion switching device using the wet type multiple disc brake. As a result, it is rendered possible, by using the forward and rearward motion switching device according to the present invention, to largely reduce a power loss due to the drag torque so as to improve the efficiency of the automatic transmission and reduce the fuel expenses.

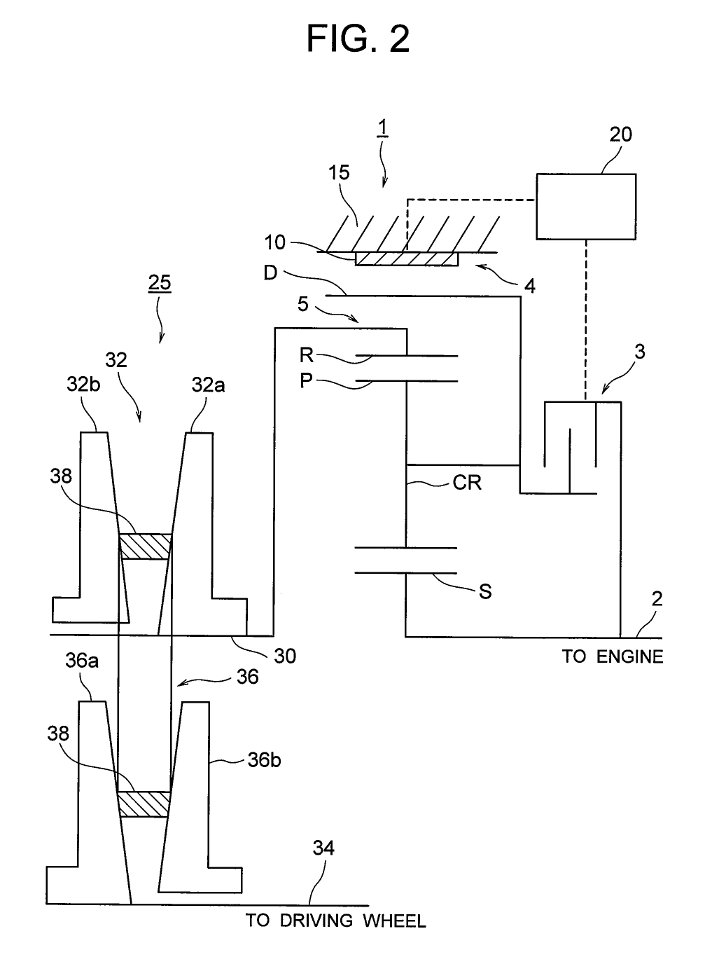

FIG. 2 is a skeleton diagram showing a structure of a forward and rearward motion switching device according to a second embodiment of the present invention. The forward and rearward motion switching device 1 according to the present embodiment employs a planetary gear mechanism 5 of a single pinion type. In the present embodiment, the planetary gear mechanism of a single pinion type is comprised of a sun gear S which is integrally coupled to an input shaft 2 to be rotatably driven, a pinion gear P which is disposed outside in the radial direction of the sun gear S and meshed with the sun gear S, a planetary carrier CR for supporting the pinion gear P to allow rotation about its own axis and revolution about the axis of the sun gear S, and a ring gear R provided with internal teeth meshed with the pinion gear P. The planetary carrier CR is integrally formed with a coaxial rotational drum D, and is releasably coupled to the input shaft 2 through a clutch 3. The outer peripheral surface of the rotational drum D is provided to be fixed by a brake 4 which will be described later with reference to FIG. 5. The ring gear R is integrally coupled to a primary shaft 30 which is coaxial with the input shaft 2 to serve as an input shaft of the continuously variable transmission 25. The structure of the continuously variable transmission 25 is the same as that in the foregoing first embodiment.

In the present embodiment, in a forward running of the vehicle, the clutch 3 is engaged through the control device 20, and a rotational driving force of the engine which is transmitted to the input shaft 2 through an unillustrated torque converter is transmitted to the sun gear S and the planetary carrier CR, whereby the sun gear S and the planetary carrier CR are integrally rotated in the same direction as the rotation of the input shaft 2. Upon the integral rotation of the sun gear S and the planetary carrier CR, the ring gear R is also integrally rotated in the same direction through the pinion gear P. That is, the sun gear S, the planetary gear CR and the ring gear R are integrally rotated in the same direction as the rotation of the input shaft 2, so that a rotation of the input shaft 2 is transmitted as it is to the primary shaft 30 of the continuously variable transmission 25 which is integrally coupled to the ring gear R. The rotational driving force in the same direction as the rotation of the input shaft 2 transmitted to the primary shaft 30 is transmitted to the driving wheels through the similar rotation transmission path to that in the forward running of the first embodiment, whereby the vehicle is enabled to run forward.

On the other hand, in rearward running of the vehicle, the clutch 3 is released or disengaged through the control device 20, and the brake 4 which will be described later with reference to FIG. 5 is fastened, thereby fixing the rotational drum D. Then, the planetary carrier CR becomes an element to be fixed. For this reason, a rotation of the engine transmitted to the input shaft 2 is transmitted to the sun gear S, and the ring gear R is rotated in the reverse direction to the rotation of the input shaft 2 through the pinion gear P. In this manner, the primary shaft 30 of the continuously variable transmission 25 integrally coupled to the ring gear R is rotated in the reverse direction to the rotation of the input shaft 2. The rotational driving force transmitted to the primary shaft 30 in the reverse direction to the rotation of the input shaft 2 is transmitted to the driving wheels through the similar rotation transmission route to that in the rearward running of the foregoing first embodiment, whereby the vehicle is enabled to run rearward.

Also in the forward and rearward motion switching device 1 of the present embodiment, the brake band 10 shown in FIG. 5 is used as the brake means for fixing the planetary carrier CR which serves as the element to be fixed of the planetary gear mechanism 5 in the rearward running of the vehicle. The structure of the brake band is the same as that of the first embodiment described above, except that an objective to be fixed by the brake band 10 is the rotational drum which is integrally and coaxially formed with the planetary carrier CR.

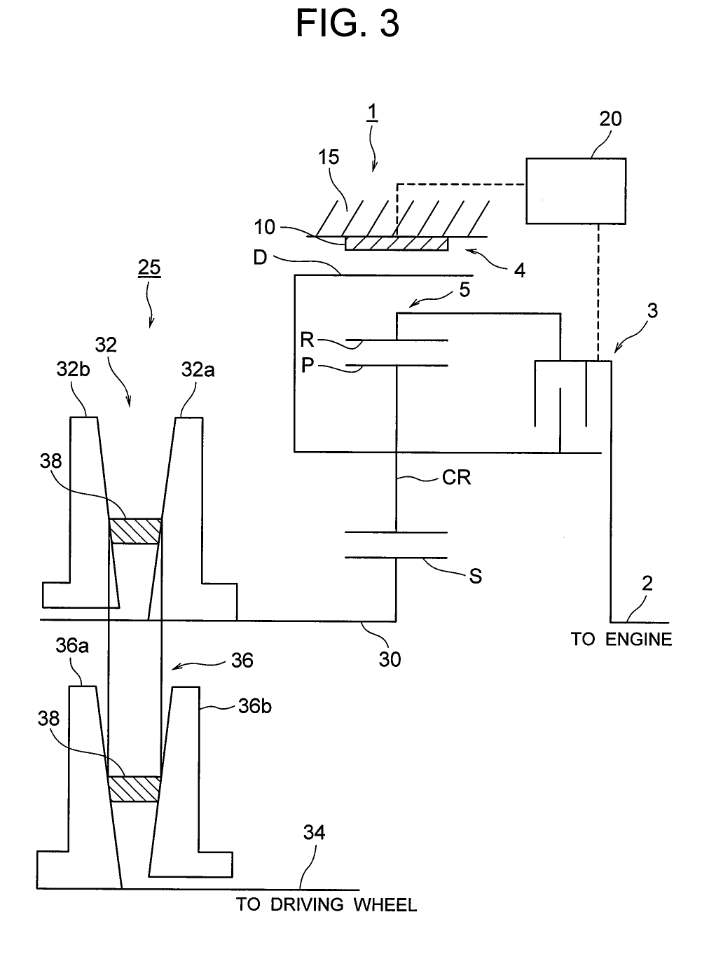

FIG. 3 is a skeleton diagram showing a forward and rearward motion switching device according to a first variation of the second embodiment of the present invention. The forward and rearward motion switching device 1 according to the present variation employs a planetary gear mechanism 5 of a single pinion type. In the present variation, the planetary gear mechanism of a single pinion type is comprised of a ring gear R which is integrally coupled to the input shaft 2 to be rotation-driven and is provided with internal teeth, a pinion gear P meshed with the ring gear R, a planetary carrier CR for supporting the pinion gear P to allow rotation about its own axis and revolution about the axis of the sun gear S, and the sun gear S meshed with the pinion gear P. The planetary carrier CR is integrally and coaxially formed with a rotational drum D, and is releasably coupled to the input shaft 2 through the clutch 3. The outer peripheral surface of the rotational drum D is provided to be fixed by the brake 4 which will be described later with reference to FIG. 5. The sun gear S is integrally coupled to the primary shaft 30 which is coaxial with the input shaft 2 to serve as an input shaft of the continuously variable transmission 25. The structural elements of the continuously variable transmission 25 are the same as those in the foregoing second embodiment.

In the present variation, in forward running of the vehicle, the clutch 3 is engaged through the control device 20, and a rotation of the engine which is transmitted to the input shaft 2 through the torque converter is transmitted to the ring gear R and the planetary carrier CR, whereby the ring gear R and the planetary carrier CR are integrally rotated in the same direction as the rotation of the input shaft 2. Upon the integral rotation of the ring gear R and the planetary carrier CR, the sun gear S is also integrally rotated in the same direction as the rotation of the input shaft 2 through the pinion gear P. That is, the sun gear S, the planetary gear CR and the ring gear R are integrally rotated in the same direction as the rotation of the input shaft 2, so that the rotation of the input shaft 2 is transmitted as it is to the primary shaft 30 of the continuously variable transmission 25 which is integrally coupled to the sun gear S. The rotational driving force in the same direction as the rotation of the input shaft 2 transmitted to the primary shaft 30 is transmitted to the driving wheel through the similar rotation transmission route to that in the forward running of the second embodiment, whereby the vehicle is enabled to run forward.

On the other hand, in rearward running of the vehicle, the clutch 3 is released or disengaged through the control device 20, and the brake 4 which will be described later with reference to FIG. 5 is fastened, thereby fixing the rotational drum D. Then, the planetary carrier CR becomes the element to be fixed. For this reason, the rotation of the engine transmitted to the input shaft 2 is transmitted to the ring gear R, and the sun gear S is rotated in the reverse direction to the rotation of the input shaft 2 through the pinion gear P. In this manner, the primary shaft 30 of the continuously variable transmission 25 integrally coupled to the sun gear S is rotated in the reverse direction to the rotation of the input shaft 2. The rotational driving force transmitted to the primary shaft 30 in the reverse direction to the rotation of the input shaft 2 is transmitted to the driving wheel through the similar rotation transmission route to that in the rearward running of the foregoing second embodiment, whereby the vehicle is enabled to run rearward.

In the forward and rearward motion switching device 1 of the present variation, the brake band 10 shown in FIG. 5 is used as the brake means for fixing the planetary carrier CR which serves as the element to be fixed of the planetary gear mechanism 5 in the rearward running of the vehicle. The structure of the brake band 10 is the same as that of the second embodiment described above.

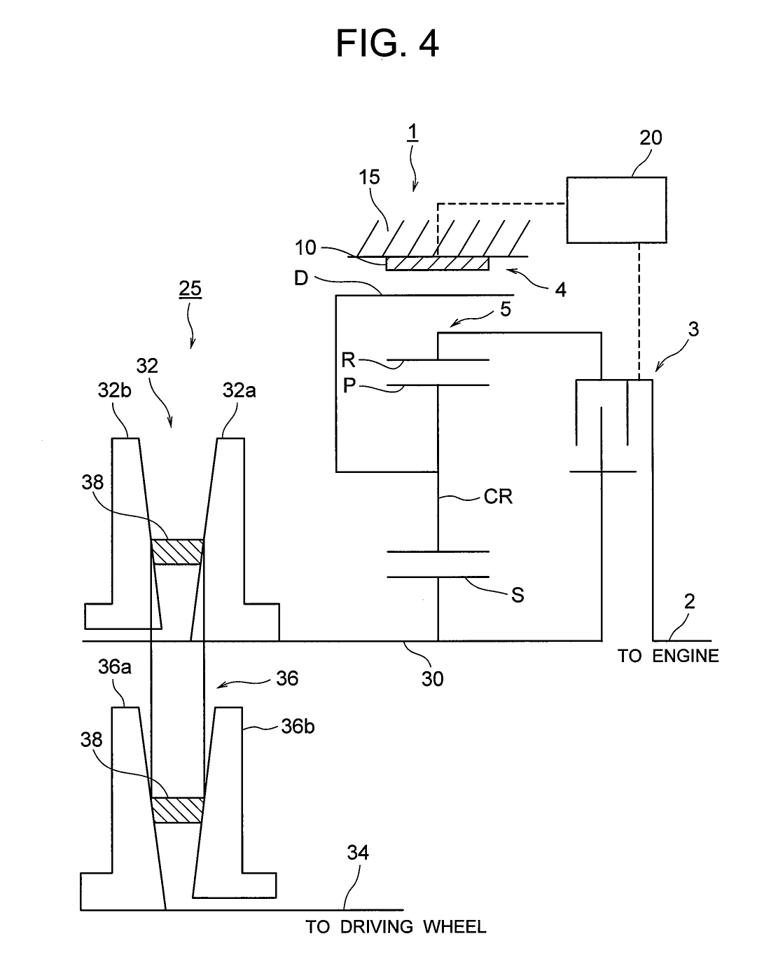

FIG. 4 is a skeleton diagram showing a forward and rearward motion switching device according to a second variation of the second embodiment of the present invention. The forward and rearward motion switching device 1 according to the present second variation employs a planetary gear mechanism of a single pinion type as the planetary gear mechanism 5. In the present variation, the planetary gear mechanism of a single pinion type is comprised of a ring gear R which is integrally coupled to the input shaft 2 to be rotatably driven and is provided with internal teeth, a pinion gear P which is disposed inside in the radial direction of the ring gear R and meshed with the ring gear R, a planetary carrier CR for supporting the pinion gear P to allow rotation about its own axis and revolution about the axis of a sun gear S, and the sun gear S meshed with the pinion gear P. The planetary carrier CR is integrally formed with a coaxial rotational drum D, and the outer peripheral surface of the rotational drum D is provided to be fixed by the brake 4 which will be described later with reference to FIG. 5. The sun gear S is integrally coupled to a primary shaft 30 which is releasably coupled to the input shaft 2 through the clutch 3 on the input side and serves as an input shaft of the continuously variable transmission 25 on the output side. The structural elements of the continuously variable transmission 25 are the same as those in the foregoing second embodiment.

In the present variation, in forward running of the vehicle, the clutch 3 is engaged through the control device 20, and the rotation of the engine which is transmitted to the input shaft 2 through the torque converter is transmitted to the ring gear R and the sun gear S, whereby the ring gear R and the sun gear S are integrally rotated in the same direction as the rotation of the input shaft 2. Upon the integral rotation of the ring gear R and the sun gear S, the planetary carrier CR is also integrally rotated in the same direction as the rotation of the input shaft 2 through the pinion gear P. That is, the sun gear S, the planetary gear CR and the ring gear R are integrally rotated in the same direction as the rotation of the input shaft 2, so that the rotation of the input shaft 2 is transmitted as it is to the primary shaft 30 of the continuously variable transmission 25 which is integrally coupled to the sun gear S. The rotational driving force in the same direction as the rotation of the input shaft 2 transmitted to the primary shaft 30 is transmitted to the driving wheels through the similar rotation transmission route to that in the forward running of the second embodiment, whereby the vehicle is enabled to run forward.

On the other hand, in rearward running of the vehicle, the clutch 3 is released or disengaged through the control device 20, and the brake 4 which will be described later with reference to FIG. 5 is fastened, thereby fixing the rotational drum D. Thus, the planetary carrier CR becomes the element to be fixed. For this reason, the rotation of the engine transmitted to the input shaft 2 is transmitted to the ring gear R, and the sun gear S is rotated in the reverse direction to the rotation of the input shaft 2 through the pinion gear P. In this manner, the primary shaft 30 of the continuously variable transmission 25 integrally coupled to the sun gear S is rotated in the reverse direction to the rotation of the input shaft 2. The rotational driving force transmitted to the primary shaft 30 in the reverse direction to the rotation of the input shaft 2 is transmitted to the driving wheels through the similar rotation transmission route to that in the rearward running of the foregoing second embodiment, whereby the vehicle is enabled to run rearward.

In the forward and rearward motion switching device 1 of the present variation, the brake band 10 shown in FIG. 5 is used as the brake means for fixing the planetary carrier CR which serves as the element to be fixed of the planetary gear mechanism 5 in the rearward running of the vehicle. The structure of the brake band 10 is the same as that of the second embodiment described above.

Also in the forward and rearward motion switching device 1 according to the second embodiment and the first and second variations of the second embodiment, the drag torque between the brake band 10 and the element to be fixed of the planetary gear mechanism 5 is, as seen from FIG. 6, is approximately a half the drag torque between the friction disc and the separator disc of the conventional forward and rearward motion switching device 1 employing the wet type multiple disc brake.

As described above, when the forward and rearward motion switching device according to the present invention is used, even in a state that the engine is in rotation and the brake of the forward and rearward motion switching device is not applied, the drag torque between the brake and the fixed element of the planetary gear mechanism is largely reduced so that the power loss is also reduced. As a result, it is possible to improve the efficiency of the automatic transmission and reduce of the fuel expenses. Particularly, when the forward and rearward motion switching device is used in CVT which is strongly required to have higher efficiency, a great effect can be obtained.

Note that, the forward and rearward motion switching device according to the present invention is not limited to the foregoing embodiments and variations, but can be modified in various manners.

1. A forward and rearward motion switching device to be used in an automatic transmission system for a vehicle, comprising:
a planetary mechanism provided with an input element, an element to be fixed and an output element which are disposed coaxially and are rotatable relative to each other, the planetary mechanism outputting a rotational driving force of an internal combustion engine transmitted to said input element as a rotational driving force in the reverse direction to the rotation of said input element from said output element through said input element, said element to be fixed and said output element; and
a brake means capable of fixing said element to be fixed of said planetary mechanism,
wherein said brake means comprises a rotational drum which is integrally formed with said element to be fixed and has an outer peripheral surface, and a brake band that surrounds the outer peripheral surface of said rotational drum to fix the same.

2. A forward and rearward motion switching device according to claim 1, wherein said planetary mechanism is a planetary gear mechanism comprising:
a sun gear;
a pinion gear disposed outside in the radial direction of said sun gear and meshed with said sun gear;
a planetary carrier for supporting said pinion gear to allow rotation and revolution thereof; and
a ring gear meshed with said sun gear through said pinion gear,
wherein each of said sun gear, said planetary carrier and said ring gear constitutes either of said input element, said element to be fixed and said output element.

3. A forward and rearward motion switching device according to claim 1, which is used in an automatic transmission system employing a continuously variable transmission.

4. A forward and rearward motion switching device according to claim 1, wherein, in said planetary gear mechanism, said sun gear constitutes said input element, said ring gear constitutes said element to be fixed and said planetary carrier constitutes said output element, and when said ring gear is fixed by said brake band a rotational driving force of said internal combustion engine transmitted to said sun gear is outputted as a rotational driving force in the reverse direction to the rotation of said sun gear from said planetary carrier through said pinion gear.

5. A forward and rearward motion switching device according to claim 1, wherein, in said planetary gear mechanism, said sun gear constitutes said input element, said planetary carrier constitutes said element to be fixed and said ring gear constitutes said output element, and when said planetary carrier is fixed by said brake band a rotational driving force of said internal combustion engine transmitted to said sun gear is outputted as a rotational driving force in the reverse direction to the rotation of said sun gear from said ring gear through said pinion gear.

6. A forward and rearward motion switching device according to claim 1, wherein, in said planetary gear mechanism, said ring gear constitutes said input element, said planetary carrier constitutes said element to be fixed and said sun gear constitutes said output element, and when said planetary carrier is fixed by said brake band a rotational driving force of said internal combustion engine transmitted to said ring gear is outputted as a rotational driving force in the reverse direction to the rotation of said ring gear from said sun gear through said pinion gear.

7. A forward and rearward motion switching device according to claim 3, wherein said output element is coupled to an input shaft of said automatic transmission system employing said continuously variable transmission.

8. A forward and rearward motion switching device according to claim 2, which is used in an automatic transmission system employing a continuously variable transmission.

9. A forward and rearward motion switching device according to claim 2, wherein, in said planetary gear mechanism, said sun gear constitutes said input element, said ring gear constitutes said element to be fixed and said planetary carrier constitutes said output element, and when said ring gear is fixed by said brake band a rotational driving force of said internal combustion engine transmitted to said sun gear is outputted as a rotational driving force in the reverse direction to the rotation of said sun gear from said planetary carrier through said pinion gear.

10. A forward and rearward motion switching device according to claim 2, wherein, in said planetary gear mechanism, said sun gear constitutes said input element, said planetary carrier constitutes said element to be fixed and said ring gear constitutes said output element, and when said planetary carrier is fixed by said brake band a rotational driving force of said internal combustion engine transmitted to said sun gear is outputted as a rotational driving force in the reverse direction to the rotation of said sun gear from said ring gear through said pinion gear.

11. A forward and rearward motion switching device according to claim 2, wherein, in said planetary gear mechanism, said ring gear constitutes said input element, said planetary carrier constitutes said element to be fixed and said sun gear constitutes said output element, and when said planetary carrier is fixed by said brake band a rotational driving force of said internal combustion engine transmitted to said ring gear is outputted as a rotational driving force in the reverse direction to the rotation of said ring gear from said sun gear through said pinion gear.

12. A forward and rearward motion switching device according to claim 8, wherein said output element is coupled to an input shaft of said automatic transmission system employing said continuously variable transmission.
